(19) United States
(12) Patent Application Publication
(10) Pub. No.: US 2011/0139086 A1
(43) Pub. Date: Jun. 16, 2011

(54) Method, Apparatus, and System for Euthanizing Large Numbers of Animals with Solid Carbon Dioxide

(76) Inventor: David BURGENER, Elmhurst, IL (US)

(21) Appl. No.: 12/639,562

(22) Filed: Dec. 16, 2009

(51) Int. Cl. A01K 29/00

(52) U.S. Cl. 119/420

(57) ABSTRACT

A blower is used to induce a flow of air through a porous container of solid carbon dioxide and the resulting stream of mixed air and gaseous carbon dioxide is mixed with the ambient atmosphere in an enclosure for euthanization of a large number of non-human animals in an enclosure.

### CROSS-REFERENCE TO RELATED APPLICATIONS

None.

### BACKGROUND

Carbon dioxide has been used for decades as an asphyxiant and also as a fumigation agent in grain storage bins and production areas. CO₂ is a naturally occurring gas that is a product of respiration. The concentration of CO₂ in the lungs of animals is a natural trigger for respiration. The higher the CO₂ level the faster the animal breathes to expel the CO₂.

Carbon Dioxide is about one and one-half times denser than air. It is typically stored as a refrigerated liquid at 300 psig (pounds per square inch gauge) and at 0° F. in insulated bulk storage tanks for commercial use. Another common form of consumption is the solid dry ice form which is at minus 110° F. at atmospheric pressure and is generally used in solid form as an expendable refrigerant. Solid dry ice is typically manufactured at centralized manufacturing plants in the form of solid blocks or slices and as pellets.

Liquid CO₂ requires approximately 120 btu/lb (British thermal units per pound) to vaporize from a liquid to a gas. Most atmospheric pressure applications of CO₂ use it in the compressed gas form and not as a liquid. Discharging liquid CO₂ from 300 psig to atmospheric pressure causes the formation of an approximately 45% by weight of solid dry ice snow and 55% by weight cold gas at −110° F. This is the same effect as observed in a CO₂ fire extinguisher. Use of liquid CO₂ as a euthanizing agent would require the installation of high pressure piping or hoses and dispersion nozzles to distribute the CO₂ gas into the area to be inerted. This can be expensive and time consuming in cases where animals in multiple enclosures must be quickly euthanized.

Thus, it is an object of the invention to euthanize non-human animals in an economical and/or rapid manner, especially when multiple enclosures of non-human animals must be treated.

Dry ice requires 250 btu/lb to sublime or change from the solid to a cold gas. Cold dry ice tends to freeze moisture on its surface from surrounding air. If a piece of dry ice is immersed in water, it rapidly sublimes to a gas by extracting heat from the surrounding water. At the same time, the water freezes on the cold (−110° F.) surface of the dry ice. It is common to see the water ice accumulate to a thickness that a water-ice shell forms around the dry ice to the point where the heat transfer slows significantly. CO₂ vapor can then become trapped inside the shell of water ice and may eventually explode due the rapid increase in CO₂ pressure from the sublimed gas.

Thus, it is an object of the invention to avoid or reduce undesirably high accumulation of water ice on the surface of the dry ice, which would inhibit the conversion of the dry ice to gaseous CO₂.

Nitrogen is another common gas that has been used as an Asphyxiant. It causes death by oxygen deprivation. It typically requires larger volumes of N₂ to cause death than CO₂ because it must displace enough oxygen to cause the animal to pass out and die. It also has a density close to that of air and is more difficult to create a concentration high enough to deplete the area of oxygen (typically greater than 95%) due to a high diffusion rate. Nitrogen has also been used for grain fumigation, but it requires higher concentrations and longer exposure times to be effective. In cases where more open structures are housing the animals, it is difficult to maintain high enough N₂ concentrations to create an effective kill rate. There is a distinct disadvantage utilizing N₂ compared to CO₂ in that a human exposed to high concentrations of CO₂ is normally warned by the body due to increased respiration and heart rates. Nitrogen exposure yields little or no warning of high levels and the subject typically passes out and dies.

Another common gas that could be used for immobilizing animals could be Nitrous Oxide. It is commonly used by dentists and doctors as an anesthesia agent. It tends to cause euphoria and calms the animal being exposed. N₂O is about ten times more expensive than CO₂ or N₂ and is therefore not commonly considered for mass euthanasia of animals. Its density is similar to CO₂ and is about one and one-half times that of air, so it tends to collect in low lying areas. It has the same disadvantage as N₂ in that death is caused by elimination of oxygen. This means that the lethal concentration must be higher than with CO₂ while having the same density and leakage rate.

Thus, it is an object of the invention to provide a euthanizing agent that is easy to use and relatively safe for operators.

For over forty years, it has been well known in the industry to use Carbon Dioxide gas for immobilizing hogs and cattle prior to slaughter. This is typically done by creating a depressed chamber or gas tight enclosure with an open top to move the animals into. The atmosphere is constantly purged with CO₂ gas in an attempt to maintain an atmosphere near 100% CO₂.

Physiologically, CO₂ can act as both an anesthesia and a euthanizing agent. At concentrations greater than 5% volume/volume (v/v) an animal will respire rapidly and will pass out in a few minutes. At levels of 10% v/v or greater, the animal will pass out and irreversibly create an acid condition in the blood stream that leads to metabolic acidosis. At extremely high CO₂ concentrations, the respiratory system shuts down and animals become anesthetized. Most of the prior art utilizes open topped enclosures that are filled with CO₂ vapor at close to 100% concentrations.

### SUMMARY

There is disclosed a method of euthanizing large amounts of non-human animals in an enclosure with carbon dioxide gas. The method comprises the following steps. An enclosure containing a plurality of non-human animals is provided. A container of solid carbon dioxide is provided in the enclosure. A flow of air through the container is induced with a blower to sublime the solid carbon dioxide and produce a stream of mixed air and gaseous carbon dioxide. The stream of mixed air and gaseous carbon dioxide is mixed with the ambient atmosphere within the enclosure.

There is also disclosed an apparatus for euthanizing large amounts of non-human animals in an enclosure with carbon dioxide gas, comprising: a main housing; a plurality of porous sub-housings arranged in parallel fashion inside the main housing; a blower having an inlet and an outlet; and a suction plenum. The main housing comprises first and second opposed side wall extending upwardly from a floor, wherein front-facing edges of the walls and floor form a main housing front face and back-facing edges of the walls and floor form a main housing back face parallel to the front face. The sub-housings are spaced apart by air channels each one of which extends from the front face to the back face. The sub-housings are adapted to be fed with solid carbon dioxide in the form of blocks or pellets. The suction plenum fluidly communicates between the blower inlet and the air channels at the back face. The plenum is adapted to receive a stream of mixed air and gaseous carbon dioxide from the air channels and solid carbon dioxide contained in the sub-housings and direct the stream of mixed air and gaseous carbon dioxide to the inlet of the blower.

There is also disclosed a system for euthanizing large amounts of non-human animals in an enclosure with carbon dioxide gas, comprising the above apparatus wherein the sub-housings are filled with solid carbon dioxide.

The method, apparatus and system may include any one or more of the following aspects:
the solid carbon dioxide is in the form of pellets or blocks.
the stream of mixed air and carbon dioxide is directed through a duct, the duct comprising a vertical portion fluidly communicating with a horizontally portion having a plurality of apertures formed therein.
the container comprises a housing containing a plurality of porous sub-housings arranged in parallel fashion.
each of the sub-housings contains an amount of the solid carbon dioxide.
the sub-housings are separated from one another by a plurality of air channels receiving the flow of air.
the sub-housings have a width, height, and length.
the width is smaller than the height and length.
the sub-housings are oriented vertically such that their width dimensions extend horizontally.
after performance of said step of mixing, an air and carbon dioxide composition within the enclosure is lethal to the non-human animals.
the carbon dioxide concentration within the enclosure after performance of said step of mixing is less than that which is sufficient to anesthetize the non-human animals.
there are a plurality of the containers within the animal enclosure.
the stream of mixed air and gaseous carbon dioxide comprises 10-50% v/v gaseous carbon dioxide and 90-50% v/v air.
an inlet plenum is included that extends out from the walls and floor at the front face to define an inlet space, the inlet plenum including a door openable to allow ambient air outside the housing to flow into the air channels.
a continuous lip is included that extends upwardly and outwardly away from upper ends of the side walls and extending upwardly and outwardly away from and between upper corners of the side walls adjacent the front face as well as upwardly and outwardly away from and between upper corners of the side walls adjacent the back face, the continuous lip forming a feed hopper adapted to allow gravity feeding of the solid carbon dioxide to the sub-housings.
a duct is included that is in fluid communication with the blower outlet, the duct comprising a vertical portion extending to a height above the main housing that fluidly communicates with a horizontal portion having a plurality of apertures formed therein to allow egress of the stream of mixed air and gaseous carbon dioxide therefrom.
the solid carbon dioxide is in the form of pellets.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is an isometric view with parts removed of a preferred system design.

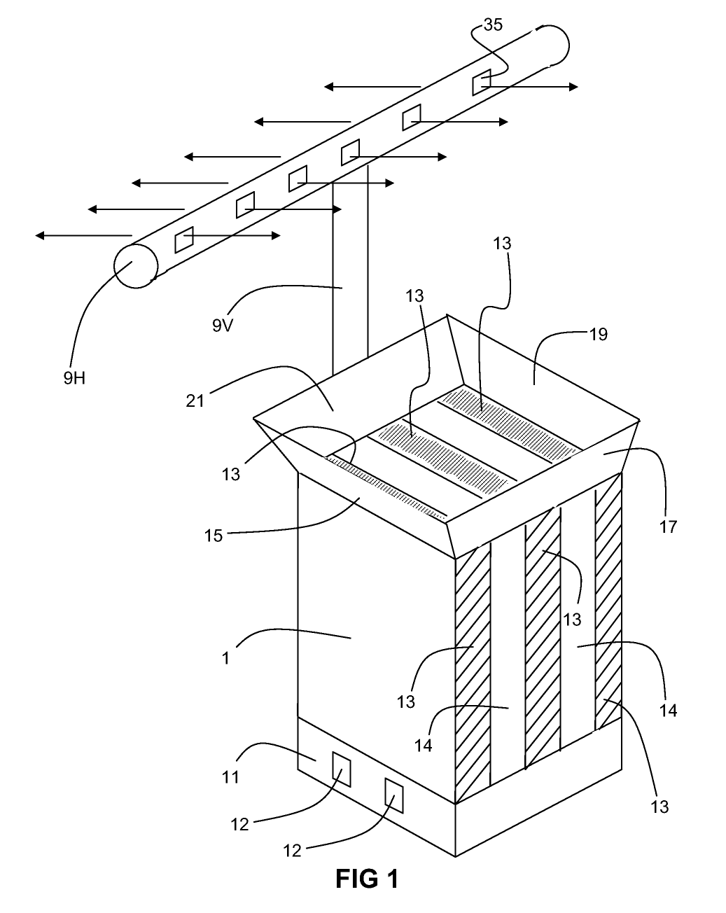

FIG. 2 is a top plan view of the preferred system design

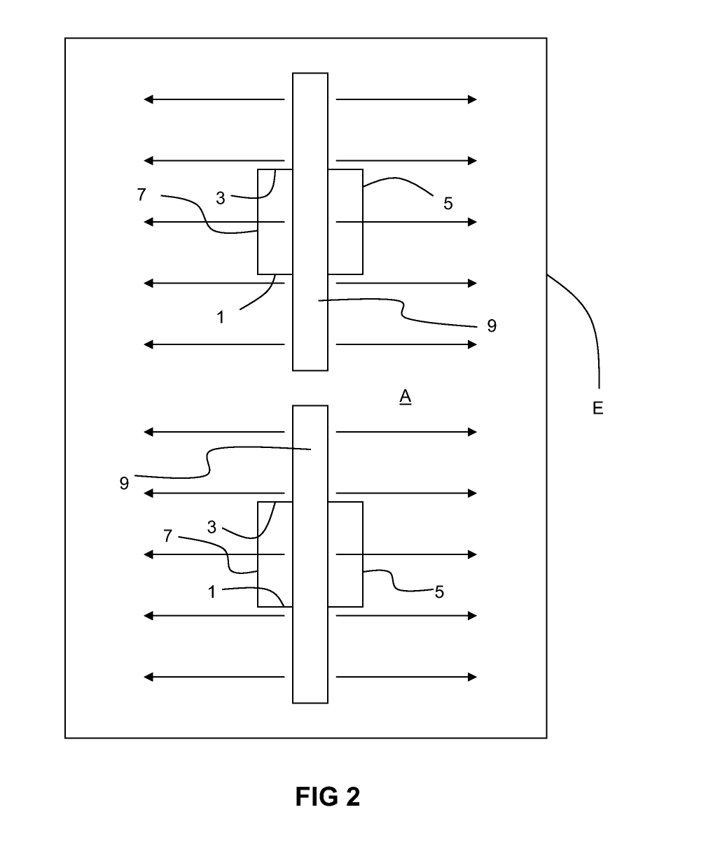

FIG. 3 is a side elevation view with parts removed of the preferred system design.

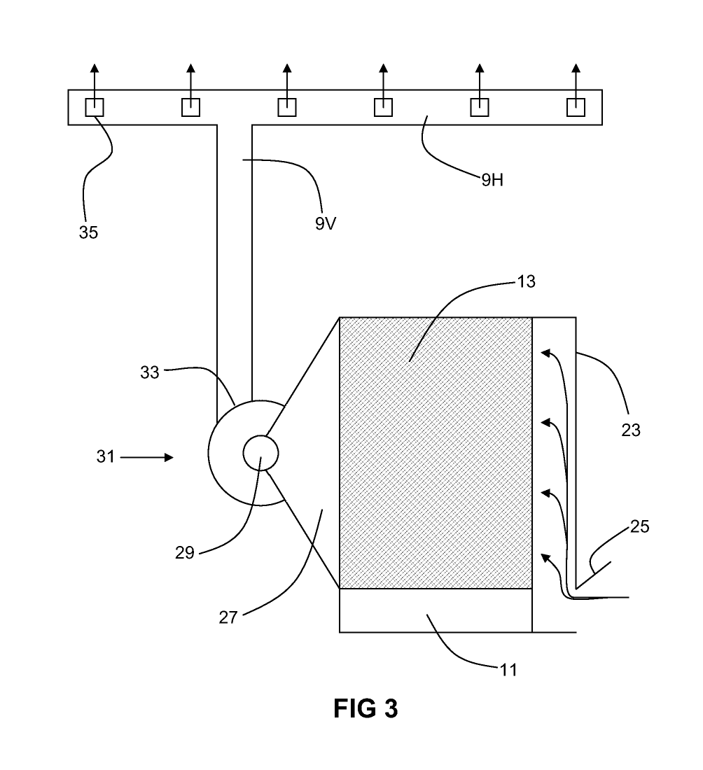

FIG. 4 is a front cross-sectional view of a variant of the preferred system design.

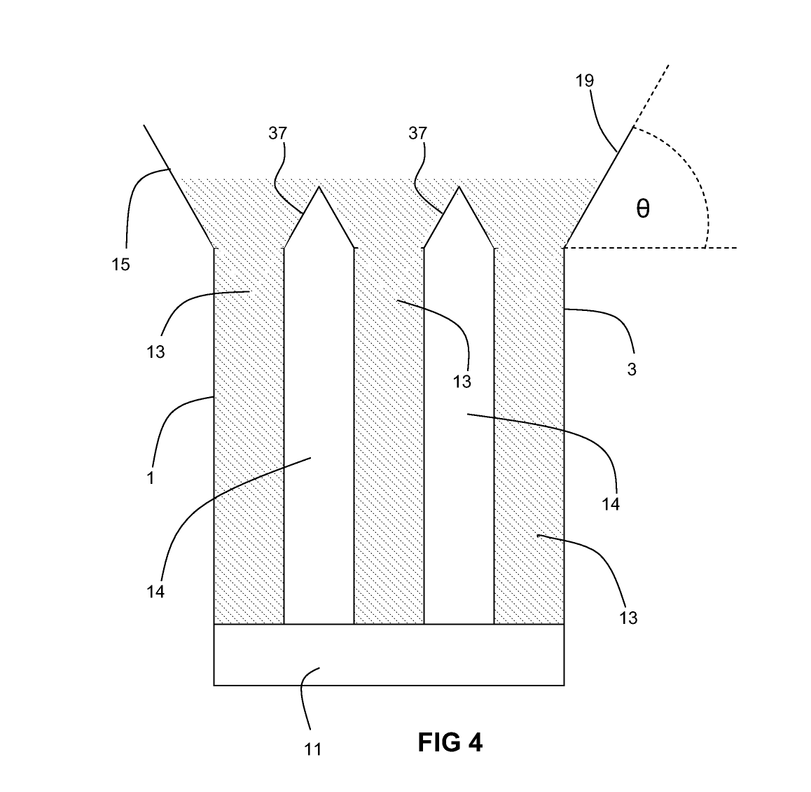

### DESCRIPTION OF PREFERRED EMBODIMENTS

The goal of the invention is to quickly and humanely euthanize large volumes of non-human animals in a confined enclosure. In cases where poultry, pigs, or other farm animals develop an illness or other situation (such as euthanization of egg-laying type poultry which no longer lay eggs) requiring rapid killing of the entire population, there is a need for a fast and efficient method of terminating the animals. It is also desirable that there be no residual chemicals that might cause harm to the humans that must remove and destroy the carcasses. It is further desirable that there be no residue that might harm the next batch of animals raised in the enclosure.

For efficiency and safety reasons, it is preferred to provide additional sealing of the enclosure in order to help contain the CO₂ gas therein. Most animal enclosures are not constructed sufficiently tight as to contain a high concentration of CO₂ without excessive makeup gases due to leakage from doors, windows and wall openings. Towards this end, the enclosure may be wrapped with a plastic film or other non-permeable membrane that would be quickly create a perimeter barrier to the rapid escape of the heavy CO₂ vapor.

One of the desires when euthanizing animals is to maintain calm and not cause panic. Panic will cause the animals to pack together and may prevent some animals from being properly exposed to the atmosphere. CO₂ has been used in slaughterhouses because it does have anesthetic qualities and reduces panic and muscle tension. This prevents tissue damage caused by panic or violent movements. When euthanizing animals there usually isn't much concern about muscle damage, but compaction and secretions can be a concern when removing the carcasses. The workers don't want to be exposed to bodily fluids any more than necessary if the reason for killing the animals is due to a medical emergency.

The invention utilizes a porous container for containing the dry ice in order to provide maximum exposure of the dry ice surface to the air. This allows rapid sublimation when air is circulated through it with a blower. Typical dry ice storage containers are heavily insulated on the exterior to reduce heat input. The dry ice is kept tightly compacted to reduce the effective surface to volume ratio. In contrast, one aspect of the invention utilizes alternating porous, vertically oriented plate-shaped sub-housings (containing the dry ice) and relatively thin, vertically oriented plate-shaped air passageways for moving the ambient air over the exposed dry ice. The relatively high surface area of the dry ice combats the accumulation of water ice on the exterior of the dry ice that slows down the sublimation process. The invention reduces the potential for reduced gas generation rates by utilizing a large exposed interior surface.

Vertically oriented sub-housings are preferred over horizontally oriented sub-housings. Vertically oriented sub-housings are those whose narrow width dimension extends horizontally and whose larger length or height dimension extends vertically. The relative humidity within animal enclosures can reach relatively high levels. For example, poultry houses routinely have relative humidities of 70% to near 100%. In such high humidity environments, a significant amount of water vapor may condense on surfaces chilled by the dry ice. The condensed water may drip down onto a top surface of the horizontally oriented sub-housing and become frozen through contact with the dry ice. As more and more condensed water drips in the same location, the frozen water may accumulate so much that it bridges in between adjacent sub-housings. This bridging will unsatisfactorily impede the flow of air through the air channel affected by the bridging. In contrast, condensed water will not drip down onto the dry ice when the sub-housing is oriented vertically. Rather, the condensed water will drip down to the base 11 where it may be drained to the floor of the animal enclosure. Vertically oriented sub-housings are additionally preferably because they allow for more effectively settling of dry ice pellets as the dry ice is consumed through sublimation. The tops of the sub-housings are thus kept open to allow dry ice pellets to be gravity fed to them from a hopper.

The apparatus exterior should include a minimum amount of insulation so that an operator may install the apparatuses inside the animal enclosure without creating a CO₂ atmosphere that is hazardous to the operator's health and safety. Nevertheless, dry ice production facilities have CO₂ vapor spilling out of containers constantly. This is safe for operators as long as the room is ventilated and they don't bend over or work near the floor level where the dense CO₂ will tend to concentrate.

The flow of air through the porous container of dry ice is achieved with a blower. A blower is defined as any device which causes a flow of a gas, and includes but is not limited to fans which pull in and expell axially-oriented flows of gas and blowers which pull in an axially-oriented flow of gas and expel a radially-oriented flow of gas. Since the blower will be subject to cold CO₂ sublimation gases, it is preferably designed such that condensed water ice won't impede normal air circulation. This may be achieved with a radial blade centrifugal blower because they tend to shed water ice accumulation due to centrifugal force. Squirrel cage type blowers and propeller fans are less preferred in high humidity environments. This is because the water ice can tend to accumulate on the rotating parts to a level that reduces air flow and the sublimation rate.

Performance of the invention achieves better results when a means of distributing the CO₂ throughout the enclosure is used. In this manner, rapid and thorough mixing of CO₂ (and air) with the surrounding atmosphere (i.e., air or CO₂-enriched air) may be accomplished. Typically, the means for distributing the CO₂ through the surrounding atmosphere in the enclosure is by using a cloth or fabric based, vertically extending duct system that can be made rigid by the pressure generated by the distribution means. Apertures (i.e., holes or pores) along the length of the duct distribute the CO₂ in the air at an elevated point above the apparatus. As the cold, dense CO₂ sinks, further mixing with the air is achieved. Alternatively, the CO₂ may be distributed throughout the enclosure with conventional rigid ducts or conduits. The duct may include only a vertical portion or it may include a vertical portion extending from the blower as well as a horizontal portion which receives the mixed air/CO2 from the vertical portion. The horizontal portion (with apertures formed therein for venting the mixed air/CO₂) will achieve greater mixing in comparison to only a duct having only a vertical portion.

While the invention may be practiced with blocks of dry ice, preferably dry ice pellets are used. The dry ice pellets have a large surface to volume ratio allowing for rapid heat transfer to food products and can be readily poured or shoveled into containers. Preferably, the pellets have an average diameter of about one eighth of an inch.

At extremely high CO₂ concentrations, the respiratory system shuts down and animals become anesthetized. This is a desired event when operating a slaughter operation where the desire is to cause the animals to go unconscious, but keep the heat pumping. This is because the animal needs to be safely inverted and bled to death to drain the blood from the animal prior to death. In contrast, the invention is designed to reduce the CO₂ concentration to increase the speed with which the animals are euthanized and reduce the leakage or loss of CO₂ from an otherwise unsealed enclosure. Typically, the blower speed (and consequently air flow rate) and the surface area of dry ice are selected such that a CO₂ concentration in the enclosure of 10-50% v/v is achieved by performance of the method.

Typically, prior art methods involved had little or no leakage problems. In contrast, this invention keeps the CO₂ concentration at a more optimal level which reduces the leakage of a gas much heavier than air. The faster the animals are asphyxiated, that less CO₂ is required and the more leakage can be tolerated during the period of exposure.

As best illustrated by the FIGS, a main housing includes a first side wall 1, a second side wall 3, and a base 11 making up a floor. The base 11 may include slots 12 adapted to receive a forklift for conveying the apparatus from location to location. A plurality of porous sub-housings 13 extend horizontally from an open front face 5 of the housing to an open back face 7 of the housing and extend vertically from the base 11 to a continuous lip. The lip includes four portions 15, 17, 19, 21 extending upwardly and outwardly in a flared fashion from the upper edges of the front face 5, back face 7, and side walls 1, 3. The lip is at an angle θ to horizontal of at least 60° to form a feed hopper adapted to allow gravity feeding of the solid carbon dioxide to the sub-housings 13. The sub-housings 13 are alternated with air channels 14 which similarly extend horizontally from an open front face 5 of the housing to an open back face 7 of the housing. The air channels 14 extend vertically from the base 11 to caps 37.

The housing may optionally include an inlet plenum 23 extending from edges of the base 11, side walls 1, 3, and lip portion 17 adjacent the front face 5. The optional inlet plenum 23 may optionally include a door 25 for enhanced safety. When the apparatus is filled with dry ice but sublimation is not desired, the optional door 25 may be closed to prevent the operator from being exposed to high CO2 vapor concentrations during the period where the device(s) are being positioned inside the animal enclosure. This may be a remotely actuated door to allow operation from outside the animal enclosure. A suction plenum 27 extends from edges of the base 11, side walls 1, 3, and lip portion 21 adjacent the back face 7 and terminates at an inlet 29 of a blower 31. A vertical portion 9V of a duct 9 extends from an outlet 33 of the blower 31 and terminates at a horizontal portion 9H of the duct 9. The horizontal portion 9H includes a plurality of apertures 35.

The side walls 1, 3, base 11, optional plenum 23, and continuous lip may be made of any generally rigid material such as metal or wood. The sub-housings 13 are made of a porous or mesh material adapted to contain the dry ice but allow sublimation. In an exemplary embodiment, the sub-housings 13 are about 2″ wide while the air channels 14 are about 2-3″ wide. This tends to reduce an undesirably high accumulation of water ice on the sub-housings 13 which can impede the flow of air through the air channels 14. The suction plenum 27, vertical portion 9V, and horizontal portion 9H may be made of a flexible material (such as fabric) or of a conventional rigid duct material (such as metal). The apertures 35 formed in the duct 9 may be relatively numerous and small or relatively few and large so long as the total cross-sectional area is sufficient to provide a desired flow rate of the gas out of the duct 9. The elevation of the duct 9 is determined by the maximum height at which the animals are housed in the enclosure E. The optimal height is slightly above the animals. In an exemplary embodiment, the duct 9 reaches a height of about 4-6′ above the floor of the enclosure E.

When a need arises for the euthanization of large numbers of non-human animals, the sub-housings 13 are filled with dry ice in the form of pellets (preferably) or blocks by feeding dry ice into the feed hopper formed by the continuous lip. The relatively high angles of the caps and the continuous lip enhance settling of the dry ice into the sub-housings. Once filled with a desired amount of dry ice, one or more of the apparatuses according to the invention are placed in an enclosure E containing the animals. If the optional door 25 is present, it is now opened. The operator exits the enclosure E and the enclosure E is provided with supplemental sealing at the door and window openings. The operator turns on the blower 31 remotely.

The blower 31 induces a flow of air from the ambient atmosphere A through the open door 25 (if present) and into an inlet space defined by an interior surface of the inlet plenum 23 and the front face 5 of the housing. The air flows through the air channels 14 in between adjacent sub-housings 13 containing the dry ice and causes an amount of the dry ice to sublime. A stream of mixed air and gaseous carbon dioxide is collected by the suction plenum 27 and directed to the blower inlet 29. The flow rate of the stream of mixed air and gaseous carbon dioxide is accelerated by the blower 31 and exits the blower outlet 33 to enter the vertical portion 9V of the duct 9. The stream of mixed air and gaseous carbon dioxide flows into the horizontal section 9H of the duct 9 and out the apertures 35.

The relatively cold (typically less than 32 F) stream of mixed air and gaseous carbon dioxide flows outwardly from the duct 9, and due to its greater density, flows downwardly to the floor of the enclosure E. Continuous operation of the blower 31 causes recirculation of the carbon dioxide-enriched ambient atmosphere through the apparatus, out towards peripheral regions of the enclosure E and back to the apparatus.

Because of the relatively high surface area of the dry ice and the forced recirculation of gas through the apparatus, the dry ice is rapidly sublimed and mixed with the ambient atmosphere A to achieve a carbon dioxide concentration of about 10% to 50% v/v. In contrast to prior art methods of euthanizing animals with high concentrations of CO₂ (typically nearing 100%), the relatively low concentration of carbon dioxide achieved by the invention may avoid the undesired anesthetization of the animals which necessitates a longer exposure time to the CO₂ in order to provide a lethal dose.

Those skilled in the art will appreciate that exposure times effective for euthanization are well established in the art for predetermined concentrations of CO₂. They will further recognize that reaching a desired CO₂ concentration within a given enclosure may be determined through simple thermodynamic calculations based upon the air flow rate, the amount of dry ice, and the volume of the enclosure. Otherwise, an effective period of time for operation of the blower 31 may be determined empirically through routine experimentation.

After the blower has been run for at least as long as it should take to euthanize the animals in the enclosure, the blower 31 is turned off and the door 25 is closed (for safety reasons, preferably remotely). Materials used to provide supplemental sealing of the window and door openings are then removed and the doors and/or windows may be opened. The exhaust fans in the enclosure may then be turned on to vent the CO₂-enriched atmosphere to achieve a habitable environment. If additional enclosures need to be treated, more dry ice may be loaded in the sub-housings 13 via the feed hopper and the system moved to the next enclosure for treatment.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

What is claimed is:

1. A method of euthanizing large amounts of non-human animals in an enclosure with carbon dioxide gas, comprising the steps of:
providing an enclosure containing a plurality of non-human animals;
providing a container of solid carbon dioxide in the enclosure;
inducing a flow of air through the container with a blower to sublime the solid carbon dioxide and produce a stream of mixed air and gaseous carbon dioxide; and
mixing the stream of mixed air and gaseous carbon dioxide with the ambient atmosphere within the enclosure.

2. The method of claim 1, wherein the solid carbon dioxide is in the form of pellets or blocks.

3. The method of claim 1, wherein the stream of mixed air and carbon dioxide is directed through a duct, the duct comprising a vertical portion fluidly communicating with a horizontally portion having a plurality of apertures formed therein.

4. The method of claim 1, wherein:
the container comprises a housing containing a plurality of porous sub-housings arranged in parallel fashion;
each of the sub-housings contains an amount of the solid carbon dioxide;
the sub-housings are separated from one another by a plurality of air channels receiving the flow of air.

5. The method of claim 4, wherein:
the sub-housings have a width, height, and length;
the width is smaller than the height and length; and
the sub-housings are oriented vertically such that their width dimensions extend horizontally.

6. The method of claim 1, wherein after performance of said step of mixing, an air and carbon dioxide composition within the enclosure is lethal to the non-human animals.

7. The method of claim 6, wherein the carbon dioxide concentration within the enclosure after performance of said step of mixing is less than that which is sufficient to anesthetize the non-human animals.

8. The method of claim 1, wherein there are a plurality of the containers within the animal enclosure.

9. The method of claim 1, wherein the stream of mixed air and gaseous carbon dioxide comprises 10-50% v/v gaseous carbon dioxide and 90-50% v/v air.

10. An apparatus for euthanizing large amounts of non-human animals in an enclosure with carbon dioxide gas, comprising:
a main housing comprising first and second opposed side wall extending upwardly from a floor, front-facing edges of the walls and floor forming a main housing front face, back-facing edges of the walls and floor forming a main housing back face parallel to the front face;
a plurality of porous sub-housings arranged in parallel fashion inside the main housing, the sub-housings being spaced apart by air channels each one of which extends from the front face to the back face, the sub-housings being adapted to be fed with solid carbon dioxide in the form of blocks or pellets;
a blower having an inlet and outlet; and
a suction plenum fluidly communicating between the blower inlet and the air channels at the back face, the plenum being adapted to receive a stream of mixed air and gaseous carbon dioxide from the air channels and solid carbon dioxide contained in the sub-housings and direct the stream of mixed air and gaseous carbon dioxide to the inlet of the blower.

11. The apparatus of claim 10, further comprising an inlet plenum extending out from the walls and floor at the front face to define an inlet space, the inlet plenum including a door openable to allow ambient air outside the housing to flow into the air channels.

12. The apparatus of claim 10, further comprising a continuous lip extending upwardly and outwardly away from upper ends of the side walls and extending upwardly and outwardly away from and between upper corners of the side walls adjacent the front face as well as upwardly and outwardly away from and between upper corners of the side walls adjacent the back face, the continuous lip forming a feed hopper adapted to allow gravity feeding of the solid carbon dioxide to the sub-housings.

13. The apparatus of claim 10, further comprising a duct in fluid communication with the blower outlet, the duct comprising a vertical portion extending to a height above the main housing that fluidly communicates with a horizontal portion having a plurality of apertures formed therein to allow egress of the stream of mixed air and gaseous carbon dioxide therefrom.

14. A system for euthanizing large amounts of non-human animals in an enclosure with carbon dioxide gas, comprising the apparatus of claim 10, wherein the sub-housings are filled with solid carbon dioxide.

15. The system of claim 14, wherein the solid carbon dioxide is in the form of pellets.
